(19) United States
(12) Patent Application Publication
(10) Pub. No.: US 2015/0211413 A1
(43) Pub. Date: Jul. 30, 2015

(54) Combustion Engine and Method of Use Resulting in Reduced Soot Emissions

(71) Applicant: Perkins Engines Company Limited, Peterborough, Cambridgeshire (GB)

(72) Inventors: Ian Evans, Peterborough (GB); David Heaton, Yarwell (GB); Timothy Bazyn, Chillicothe, IL (US); Christopher Gehrke, Chillicothe, IL (US); Darren Ellis, Peterborough (GB); Glen Martin, Peoria, IL (US)

(73) Assignee: Perkins Engines Company Limited, Peterborough, Cambridgeshire (GB)

(21) Appl. No.: 14/417,463

(22) PCT Filed: Jul. 26, 2013
(86) PCT No.: PCT/GB2013/052005

§ 371 Date: Jan. 26, 2015

(30) Foreign Application Priority Data
Jul. 27, 2012 (GB) 1213464.9

(51) Int. Cl. F02B 3/08; F02M 61/18

(52) U.S. Cl. CPC F02B 3/08; F02M 61/1846

(57) ABSTRACT

It may be necessary to eliminate soot from combustion engine emissions in order to comply with regulatory requirements. It may be desirable to avoid the need for a separate aftertreatment apparatus in order to eliminate soot from combustion engine emissions.

A compression ignition engine may be configured to result in combustion having a peak value of equivalence ratio of less than 4.0 at the lift off length of the flame. This may result in particulate emissions of fewer than 1012 particles per kWh.

### TECHNICAL FIELD

The disclosure relates to the field of combustion engines having reduced soot emissions.

### BACKGROUND

In order to comply with regulatory requirements in relation to emissions, such as soot from combustion engines, it is known to provide exhaust fluid treatment apparatus to receive and treat exhaust fluid emitted by the combustion engine. Such apparatus has an associated cost and level of complexity that may not be appropriate, for example, in a low cost engine.

Regulations in relation to emissions may specify maximum numbers of particles (i.e., soot) permitted to be emitted as well as maximum sizes of particles permitted to be emitted.

A quantity of soot emitted from a combustion engine may be influenced by a number of parameters including a ratio of fuel to oxidiser (e.g., air) in the combustion cylinder, injection pressure of fuel into the combustion cylinder and temperature of gas within the combustion cylinder. The ratio of fuel to air injected into the cylinder may be expressed in terms of an equivalence ratio, wherein the equivalence ratio is defined as the ratio of the fuel-to-oxidizer ratio to a stoichiometric fuel-to-oxidizer ratio. For a stoichiometric ratio of fuel to oxidiser, the equivalence ratio is 1.

Against this background, there is provided a compression ignition engine.

### SUMMARY OF THE INVENTION

A compression ignition engine comprising a combustion cylinder, the combustion cylinder comprising an injector configured to inject fuel into the cylinder for mixing with air in the cylinder so as to result in combustion, said combustion beginning at a liftoff length from the injector, wherein the engine is configured such that a peak value of an equivalence ratio at the liftoff length is less than 4.0 such that the combustion results in particulate emissions of fewer than 10¹² particles per kWh.

Specific embodiments of the disclosure will now be described, by way of example only, with reference in the accompanying drawings in which:

### BRIEF DESCRIPTION OF THE DRAWINGS

FIG. 1 shows a schematic diagram of a flame produced in accordance with the disclosure by comparison with a conventional combustion flame;

FIG. 2 shows a schematic drawing of a combustion apparatus used to demonstrate the flame produced in accordance with the disclosure;

FIGS. 3a and 3b show data for specific results obtained using the specific embodiment of FIG. 2;

FIG. 4 shows a comparison of soot emissions when operating an engine at 200 MPa versus 240 MPa; and

FIG. 5 shoes a comparison of soot emissions for different injector sizes and different numbers of injector nozzles.

### DETAILED DESCRIPTION

Experiments have been undertaken to determine how the nature of a combustion flame in a combustion chamber may be influenced in order to seek to reduce a number of soot particles emitted from the combustion chamber.

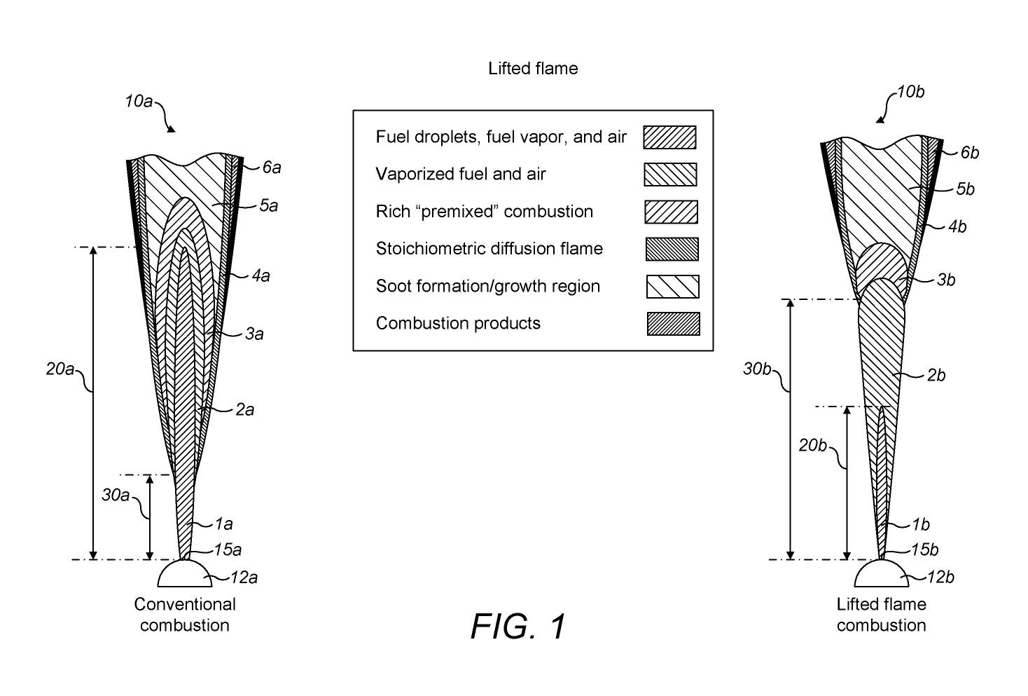

FIG. 1 shows a schematic diagram of a flame 10b produced in accordance with the disclosure by comparison with a flame 10a produced in accordance with a known combustion regime.

The flame 10a, 10b in both cases comprises: a first region 1 comprising fuel droplets, fuel vapour and air, a second region comprising vaporized fuel and air 2, a third region of rich premixed combustion 3, a fourth region of stoichiometric diffusion flame 4, a fifth region of soot formation and growth 5 and a sixth region of combustion products 6. While the two flames 10a, 10b have these regions in common, the relative sizes and positions of the regions vary significantly between the two flames 10a, 10b.

In the case of the conventional combustion flame 10a, a length of the first region 1, called the liquid length 20a, is considerably longer than the liquid length 20b for the combustion flame 10b in accordance with the disclosure. The volume occupied by vaporized fuel and air 2 is small in the conventional flame 10a and considerably larger in the flame in accordance with the disclosure 10b.

A distance, called liftoff length 30, between the injector nozzle 15 and the start of the stoichiometric diffusion flame 4 (i.e., that part of the flame 4 closest to the nozzle) is shorter in the conventional flame 10a than in the flame in accordance with the disclosure 10b.

For the conventional flame 10a, the liquid length 20a is considerably longer than the liftoff length 30a. By contrast, for the flame in accordance with the present disclosure, the liftoff length 30b is considerably longer than the liquid length 20b.

As fuel travels away from the injector 12a, 12b it vaporizes and mixes with surrounding air. In an enclosed space, such as a combustion cylinder, for a particular fuel (having a particular calorific value) there may be a particular ratio of fuel to air that results in complete combustion. This is known as the stoichiometric ratio. Where the ratio of fuel to air is stoichiometric this is known as an equivalence ratio of 1.0 and soot will not be produced.

The nature of the flame may vary in three dimensions. Considering the flame in cross-section at a particular length from the injector nozzle (e.g., at the liftoff length) may reveal that the make-up of the flame is different at the centre (where the injected fuel may be most concentrated) from at the edge (where the proportion of air may be higher). As such, the ratio of fuel to air (and hence the equivalence ratio) may vary with radial distance from the centre of the flame.

Furthermore, the ratio of fuel to air (and hence the equivalence ratio) may vary along the length of the flame. In other words, at the point of injection there may be substantially all fuel and substantially no air. Thus, the equivalence ratio may be approaching infinity. With distance from the injector 12a, 12b the equivalence ratio may increase as more air is entrained in the fuel. At each particular distance from the injector, the equivalence ratio may not be constant. For example, the equivalence ratio at a centre of a fuel jet may have a greater proportion of fuel than the equivalence ratio at the perimeter of a fuel jet, even at the same distance from the injector. Thus, the equivalence ratio at the centre of the jet may be higher than the equivalence ratio at the edge of the jet, both measured at the same distance from the injector. At any particular distance from the jet, the peak equivalence ratio may be at the centre of the fuel jet.

Peak equivalence at the liftoff length may mean the highest value for equivalence ratio at any point in the flame which is at the liftoff length.

In the case of the conventional flame 10a it has been shown that at the liftoff length the peak equivalence ratio may be in the region of 8 to 10.

By arranging a flame 10b to combust in accordance with the present disclosure it has been shown that the peak equivalence ratio at the liftoff length is likely to be in the region of less than 4.0, preferably less than 3.0 and even more preferably less than 2.0. By reducing the peak equivalence ratio at the liftoff length to be less than 4.0, it has been shown that the number of soot particles resulting from combustion may be considerably reduced by comparison with the conventional flame 10a. In particular, the number of soot particles may be reduced to fewer than 10¹² particles per kWh.

Parameters which may influence liftoff length include: fuel injection pressure, size of injector nozzle(s), number of injector nozzles, re-entrainment, intake manifold temperature, timing and duration, liquid length, exhaust gas recirculation and effective compression ratio. The following paragraphs provide a brief explanation of the relevance of each of these factors.

The values for each of these different parameters may be chosen in order to achieve a cross-sectional average equivalence ratio at the liftoff length of less than 4.0, preferably less than 3.0 and more preferably less than 2.0 for achieving a flame with minimal particle emissions.

The particular combinations of values for the various parameters focus on the impact on the likelihood of achieving a minimal soot emissions lifted flame and not on the engine out particle emissions. In cases where a flame with minimal soot emissions lifted flame is not achieved, factors that would decrease the average equivalence ratio at the liftoff length may not necessarily correlate well with decreasing the engine out particle emissions because of oxidation effects.

The following paragraphs provide a brief explanation of the relevance of each of the parameters.

Injection pressure: Increasing injection pressure may improve the likelihood of achieving a flame with minimal particle emissions by increasing the liftoff length. There may be some variation in the impact of increasing injection pressure on the cross-sectional average equivalence ratio at a give axial location in the jet. Some indicate an insignificant impact and others show a slight increase in the measured equivalence ratio at a given axial position, but in both cases the increase in the liftoff length from the increase in injection pressure may be the dominant trend that would cause a decrease in the cross-sectional average equivalence ratio at the new longer liftoff length.

Hole diameter: Decreasing the orifice diameter of the injection nozzle(s) may reduce the liftoff length and increase the rate of air entrainment. The increase in the mixing rate may be more significant than the decrease in the liftoff length such that the net effect of decreasing the hole size may be to reduce the cross-sectional average equivalence ratio at the liftoff length and correspondingly increase the likelihood of achieving a flame with minimal particle emissions.

Number of holes (orifice spacing): Increasing the number of holes beyond a certain point may cause jet-jet interactions. Jet-jet interactions may reduce liftoff length by impacting reentrainment. If the jet-jet interaction increases jet penetration rate then jet interaction with the bowl and potential re-entrainment may occur earlier. Re-entrainment of hot combustion gasses upstream of the liftoff length may reduce the liftoff length. As an alternative, if the liftoff length is driven by the strain-based extinction limit in the jet, then the proximity of another jet may reduce strain rates in the liftoff region so that the extinction strain rate and liftoff length may move upstream of their isolated jet locations. Additionally, as jets are moved closer together a heating effect from the combustion in neighbouring jets may possibly increase the temperature of the entrained gas. In any of these cases (re-entraining combustion products upstream of the isolated liftoff length, reducing strain rates and reducing the liftoff length, combustion heating effects), the impact of jet-jet interaction may be to reduce the liftoff length without increasing mixing, so the average equivalence ratio at the liftoff length may increase and the likelihood of achieving a flame with minimal particle emissions may decrease. Experimental work indicates that orifice spacing less than 36 degrees may lead to interaction between the jets and a reduction in the liftoff length.

Re-entrainment (spray targeting, duration, bowl design): If re-entrainment of hot combustion gases occurs upstream of the expected liftoff length (based on an isolated injection without any surface interaction), then the liftoff length may be reduced. Re-entrainment may be influenced by timing, number of orifices, injection duration, injection pressure, and in-cylinder geometry. A reduction in liftoff length driven by re-entrainment may not increase mixing at the same time, so the average equivalence ratio at the liftoff length may increase and correspondingly the likelihood of a flame with minimal particle emissions may be reduced.

Intake manifold temperature: Reducing intake manifold temperature and the corresponding reduction in the in-cylinder gas temperatures may increase the ignition delay and likely reduce the extinction-based strain rates such that the liftoff length may increase regardless of whether it is driven by the chemical residence time or the extinction strain rate. While lower in-cylinder temperatures may increase the liftoff length and may make it more likely that a flame with minimal particle emissions will be achieved, if a flame with minimal particle emissions is not achieved the lower in-cylinder temperatures may reduce the soot formation rates but may also reduce the oxidation rates for the soot that is formed. As a result, reducing intake manifold temperature in a case that does not achieve a flame with minimal particle emissions may result in an increase in the engine out soot even though it decreases the cross-sectional average equivalence ratio at the liftoff length.

Timing and duration (start of injection (SOI) and end of injection (EOI)): A longer duration injection may have a higher likelihood of re-entrainment as the combustion gases are directed back towards the nozzle. If re-entrainment occurs upstream of the liftoff length, then the liftoff length may decrease without an increase in mixing resulting in a higher average equivalence ratio at the liftoff length and a lower likelihood of a flame with minimal particle emissions. SOI may influence the spray targeting and may have a corresponding impact on the likelihood of re-entrainment.

Liquid length: Changes in the liquid length as a result of changes to other parameters may have minimal impact because the liquid length may be substantially shorter than the liftoff length for all cases that would come close to achieving a flame with minimal particle emissions.

Exhaust gas recirculation (oxygen concentration): When the impact of exhaust gas recirculation (EGR) on oxygen concentration is evaluated separately from the impact on temperatures, then the trends with EGR may be more easily discussed. For conditions with a small orifice where a flame with minimal particle emissions exists, reducing oxygen concentration with EGR without changing gas temperatures may maintain the flame with minimal particle emissions. The flame with minimal particle emissions may be maintained with the reduced oxygen concentrations because the liftoff length increases and the average equivalence ratio at the liftoff length remains unchanged. On the other hand, however, changing the oxygen concentration may change the average equivalence ratio at the liftoff length with a minimum value occurring for intermediate oxygen concentrations. Changing oxygen concentration without changing temperature may change the liftoff length without changing the average equivalence ratio at the liftoff length. If the in-cylinder gas temperature is increased in connection with the reduced oxygen concentration via EGR, then it is the average equivalence ratio at the liftoff length may increase and the likelihood of achieving a flame with minimal particle emissions may be reduced.

Effective or geometric compression ratio (IVA): Lowering the in-cylinder temperatures (temperature of the entrained gas) by reducing the geometric or effective compression ratio may increase the liftoff length and allow more mixing to occur prior to the liftoff length thereby increasing the likelihood of achieving a flame with minimal particle emissions.

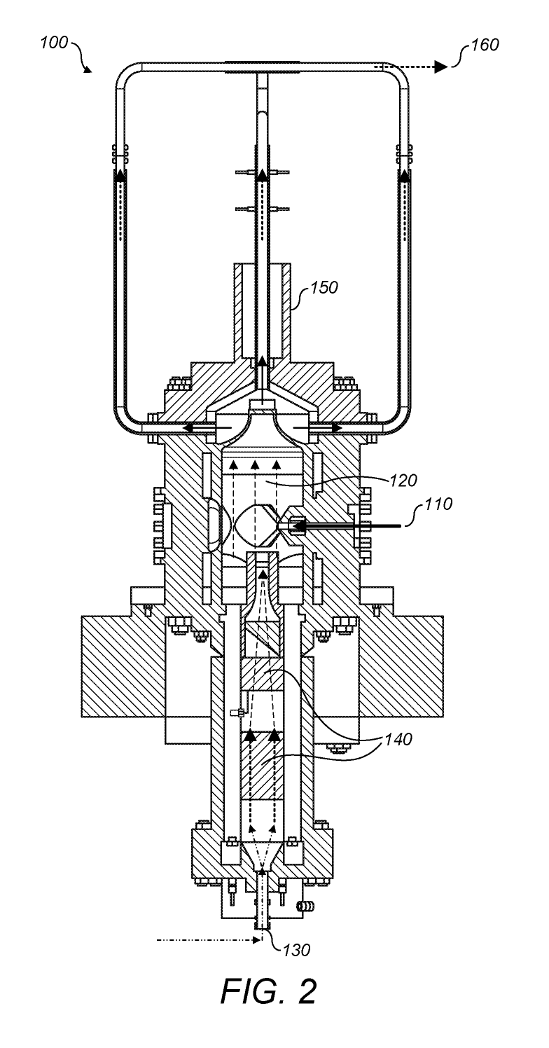

FIG. 2 shows an apparatus 100 for achieving a flame with minimal soot emissions in accordance with the present invention.

The apparatus 100 comprises an oxidiser intake 130, a fuel injector 110 and a combustion chamber 120 in the form of a combustion cylinder. The apparatus further comprises heaters 140 for altering temperature of the oxidising gas. The apparatus further comprises apparatus 150 for measuring the emissions generated and an exhaust outlet 160.

In use, oxidising gas (i.e., oxygen or air) arrives at the combustion chamber 120 via the oxidiser intake 130 and fuel arrives at the combustion chamber 120 via the fuel injector 110. Combustion takes place in the combustion chamber 120. Exhaust fluids pass out of the combustion chamber 120 and are analysed in the measuring apparatus 150 before being released through outlet 160.

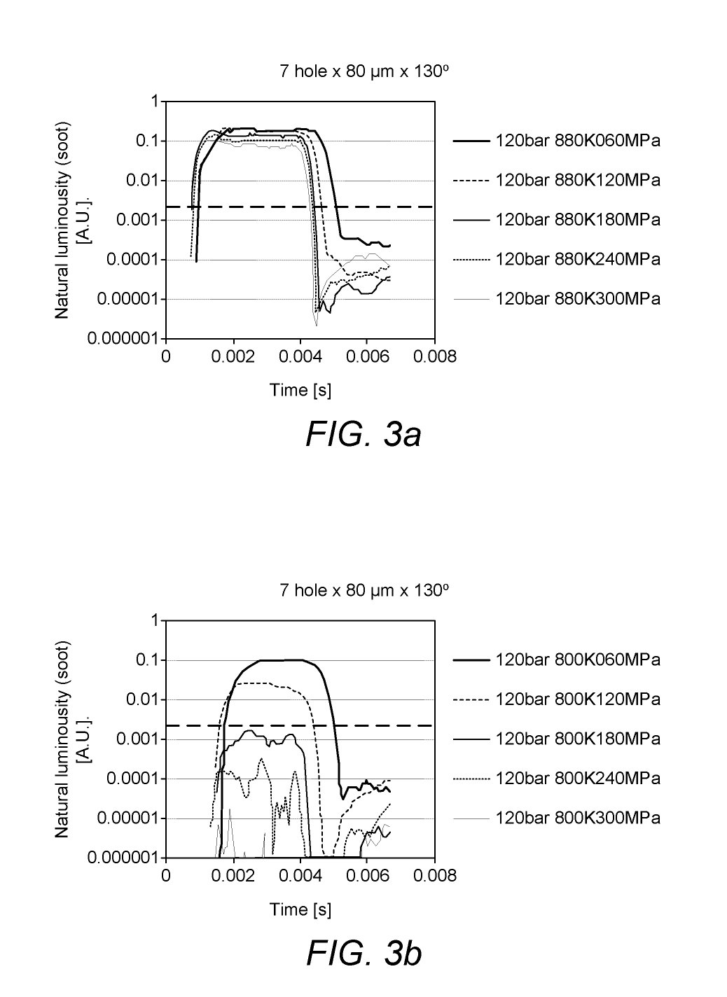

Data for specific results obtained using the specific embodiment of FIG. 2 are illustrated in FIGS. 3a and 3b. In the specific embodiment, the injector may comprise 7 nozzles, each 80 μm in diameter and distributed at 130° . The rail pressure may be between 60 and 300 MPa while the ambient pressure may be 12 MPa. The temperature in the cylinder may be between 886 K and 804 K (corrected values from 880 K and 800 K, as shown in the FIGS. 3a and 3b). Soot measurements may be detected by measuring natural luminosity (NL) of exhaust fluid. A value of NL=0.003 may correspond to conditions which show no appreciable soot.

Comparison of the two conditions shown in FIGS. 3a and 3b using NL=0.003 as the dividing line between sooting and sootless conditions indicates that 300 MPa injection may transition from sootless to sooting between an ambient temperature of 804 K and 886 K. Thus it may be desirable to use the following parameters in seeking to achieve a flame with minimal soot emissions:

Nozzle number: 7

Nozzle diameter: 80 μm

Nozzle distribution: 130°

Ambient temperature: 804 K

Ambient pressure: 12 MPa

Engine rail pressure: >180 MPa

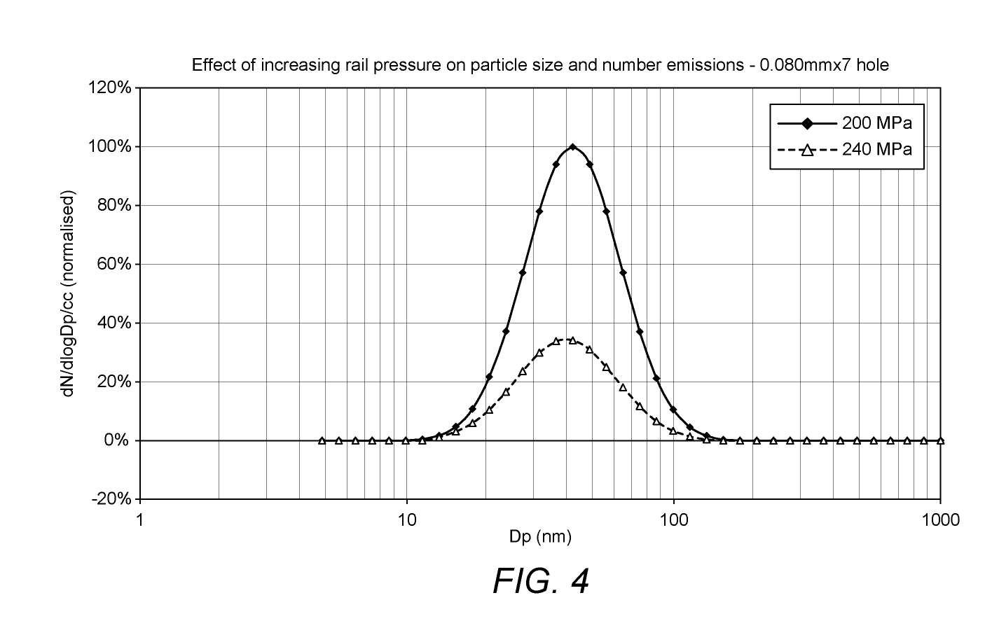

FIG. 4 illustrates the extent of the reduction in soot by increasing the pressure from 200 MPa to 240 MPa.

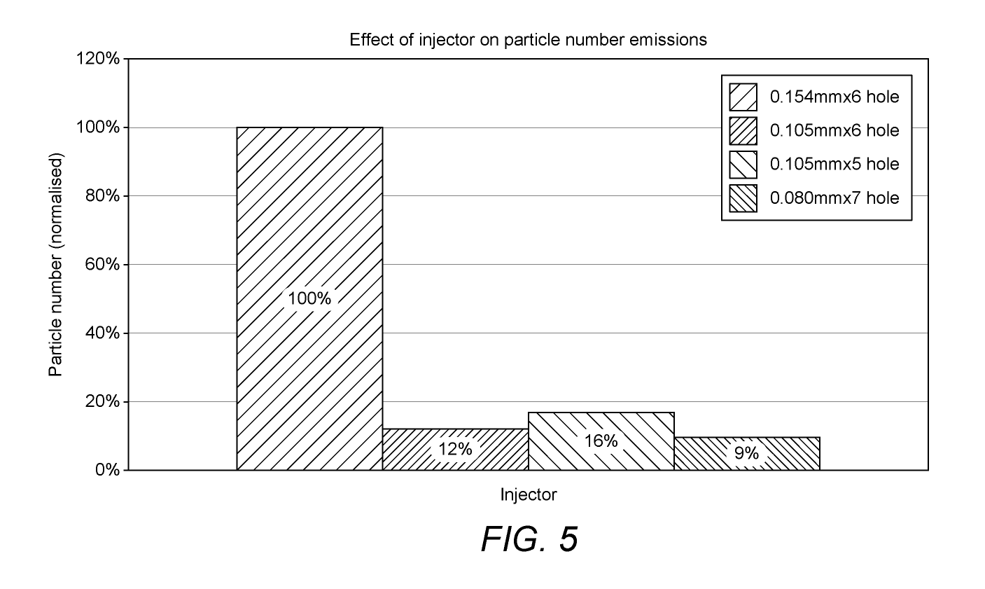

FIG. 5 illustrates the reduction in soot by reducing injector nozzle hole diameter size from 154 μm to 80 μm or 105 μm and by increasing the number of injector nozzle holes.

While the disclosure has been explained with reference to specific embodiments and particular combinations of values, the skilled person will appreciate that the scope of the disclosure is not to be limited to the particular apparatus of the specific embodiment or to any of the particular combinations of parameters disclosed as resulting in a flame with minimal soot emissions. Rather, the scope of the disclosure should be understood with reference to the appended claims.

1. A compression ignition engine comprising a combustion cylinder, the combustion cylinder comprising an injector configured to inject fuel into the cylinder for mixing with air in the cylinder so as to result in combustion, said combustion beginning at a liftoff length from the injector, wherein the engine is configured such that a peak value of an equivalence ratio at the liftoff length is less than 4.0 such that the combustion results in particulate emissions of fewer than 1012 particles per kWh.

2. The compression ignition engine of claim 1 wherein the engine is configured such that peak value of equivalence ratio at the liftoff length is configured to be less than 3.0.

3. The compression ignition engine of claim 2 wherein the engine is configured such that peak value of equivalence ratio at the liftoff length is configured to be approximately 2.0.

4. The compression ignition engine of claim 1 wherein the injector comprises at least one injection nozzle, and wherein each injection nozzle of the at least one injection nozzle has a diameter of between 80 μm and 110 μm.

5. The compression ignition engine of claim 1 wherein the engine is configured such that fuel injection pressure is between 240 MPa and 300 MPa.

6. The compression ignition engine of claim 1 wherein a temperature of the unburned gas within the cylinder is configured to be less than 880 K.

7. A method of controlling a compression ignition engine, the compression ignition engine comprising a combustion cylinder, the combustion cylinder comprising an injector configured to inject fuel into the cylinder for mixing with air in the cylinder so as to result in combustion, said combustion beginning at a liftoff length from the injector, the method comprising:
controlling the engine such that a peak value of an equivalence ratio at the liftoff length is less than 4.0 such that the combustion results in particulate emissions of fewer than 1012 particles per kWh.

8. The method of claim 7 further comprising controlling the engine such that a peak value of an equivalence ratio at the liftoff length of less than 3.0.

9. The method of claim 8 further comprising controlling the engine such that a peak value of an equivalence ratio at the liftoff length of approximately 2.0.

10. The method of claim 7 further comprising maintaining the fuel injection pressure between 240 MPa and 300 MPa.

11. The method of claim 7 further comprising maintaining a temperature of the unburned gas within the cylinder to be less than 880 K.

12-13. (canceled)

14. The compression ignition engine of claim 2 wherein the injector comprises at least one injection nozzle, and wherein each injection nozzle of the at least one injection nozzle has a diameter of between 80 μm and 110 μm.

15. The compression ignition engine of claim 2 wherein the engine is configured such that fuel injection pressure is between 240 MPa and 300 MPa.

16. The compression ignition engine of claim 2 wherein a temperature of the unburned gas within the cylinder is configured to be less than 880 K.

17. The compression ignition engine of claim 4 wherein the engine is configured such that fuel injection pressure is between 240 MPa and 300 MPa.

18. The compression ignition engine of claim 4 wherein a temperature of the unburned gas within the cylinder is configured to be less than 880 K.

19. The compression ignition engine of claim 3 wherein the injector comprises at least one injection nozzle, and wherein each injection nozzle of the at least one injection nozzle has a diameter of between 80 μm and 110 μm.

20. The method of claim 8 further comprising maintaining the fuel injection pressure between 240 MPa and 300 MPa.

21. The method of claim 8 further comprising maintaining a temperature of the unburned gas within the cylinder to be less than 880 K.

22. The method of claim 10 further comprising maintaining a temperature of the unburned gas within the cylinder to be less than 880 K.
